(19) United States
(12) Patent Application Publication
(10) Pub. No.: US 2024/0256638 A1
(43) Pub. Date: Aug. 1, 2024

(54) SYNTHETIC DATA CREATION USING COUNTERFACTUALS

(71) Applicant: Intuit Inc., Mountain View, CA (US)

(72) Inventors: Yair HORESH, Kfar Sava (IL); Aviv BEN ARIE, Ramat Gan (IL)

(73) Assignee: Intuit Inc., Mountain View, CA (US)

(21) Appl. No.: 18/102,662

(22) Filed: Jan. 27, 2023

(51) Int. Cl. G06F 18/241; G06F 18/2431

(52) U.S. Cl. CPC G06F 18/241; G06F 18/214; G06F 18/2431; G06N 20/00

(57) ABSTRACT

Methods and computer systems are provided for generating synthetic data. A real vector is generated representing real data. Using a classification model, a first output vector that represents a first class is generated from the real vector. the real vector is mutated to generate a counterfactual vector. using the classification model, the second output vector that represents a second class is generated from the counterfactual vector. the counterfactual vector is then mutated to generate a synthetic vector. Using the classification model, a third output vector that corresponds to the first class is generated from the synthetic vector, synthetic data is generated from the synthetic vector.

### BACKGROUND

Data management systems have a need to efficiently manage and generate synthetic data that appear realistic. Synthetic data includes, for example, anonymized actual data or fake data. Synthetic data is used in a wide variety of fields and systems, including public health systems, financial systems, environmental monitoring systems, product development systems, and other systems. Synthetic data may be needed where actual data reflecting real-world conditions, events, and/or measurements are unavailable or where confidentiality is required.

Synthetic data may be used in methods of data compression to create or recreate a realistic, larger-scale data set from a smaller, compressed dataset (e.g., as in image or video compression). Synthetic data may be desirable or needed for multidimensional datasets (e.g., data with more than three dimensions). However, conventional systems and methods of generating synthetic data generally suffer from deficiencies, failing to produce a diverse set of synthetic data that accurately depicts the real data.

### SUMMARY

In general, one or more aspects of the disclosure relates to a method for generating synthetic data a real vector is generated representing real data. Using a classification model, a first output vector that represents a first class is generated from the real vector. the real vector is mutated to generate a counterfactual vector. using the classification model, the second output vector that represents a second class is generated from the counterfactual vector. the counterfactual vector is then mutated to generate a synthetic vector. Using the classification model, a third output vector that corresponds to the first class is generated from the synthetic vector, synthetic data is generated from the synthetic vector.

In general, one or more aspects of the disclosure relates to a method for generating synthetic data to train a target model. A real vector that represents real data is generated. Processing the real vector with a model generates a first output vector that corresponds to a first class. the real vector is mutated to generate a counterfactual vector. Processing the counterfactual vector with the model generates a second output vector that corresponds to a second class. The counterfactual vector is mutated to generate a synthetic vector. Processing the synthetic vector with the model or a third output actor that corresponds to the first class. Synthetic data is generated from the synthetic vector. The synthetic data is used to train a target model.

In general, one or more aspects of the disclosure relates to a system that includes a computer processor and a memory with instructions that are executable by the computer processor stored in the memory. when executed, the instructions calls the computer processor to perform operations comprising: generating real vector that represents real data; generating, by a classification model from the real vector, a first output vector that corresponds to a first class; mutating the real vector to generate a counterfactual vector; generating, by the classification model from the counterfactual vector, a second output vector that corresponds to a second class; mutating the counterfactual vector to generate a synthetic vector; generating, by the classification model from the synthetic vector, a third output vector that corresponds to the first class; and generating synthetic data from the synthetic vector.

Other aspects of the invention will be apparent from the following description and the appended claims.

### BRIEF DESCRIPTION OF DRAWINGS

FIG. 1 shows a diagram of a system that is illustrated in accordance with one or more embodiments.

FIG. 2 shows a training application for training a machine learning model according to one or more illustrative embodiments.

FIG. 3 shows a data generator according to one or more illustrative embodiments.

FIG. 4 shows a process for generating synthetic data according to one or more illustrative embodiments.

FIG. 5 shows a process for generating synthetic data according to one or more illustrative embodiments

FIG. 6 shows a computing system in accordance with one or more embodiments of the invention.

Like elements in the various figures are denoted by like reference numerals for consistency.

### DETAILED DESCRIPTION

In general, embodiments are directed to systems and methods that take advantage of counterfactual generation algorithms to generate synthetic data. taking real data as input, a counterfactual data point is generated. taking the new counterfactual as input, synthetic data is then generated, returning the counterfactual data point back to its original class.

For example, consider a data point that should be cloned and changed as part of a synthetic data set generation. Using a counterfactual generation library, a counterfactual is generated from the original data point. The counterfactual is to a different class. using this newly created counterfactual, a second counterfactual is generated belonging to the class of the original data point.

The process of re-iterating the counterfactual generation can be done more than once (e.g., going back and forth between the new and original data classes multiple times), and can be done on multiple classes (more than two classes, if relevant). By that creating synthetic points that are more diverse and different from the original data point

Various constraints can be applied to minimize similarities between the existing data point and the newly generated synthetic data. The constraints are used to control the distance between the existing data points. Constraint mechanisms are applied with the goal creating realistic counterfactuals that make sense given interrelations among data features for the original data. For example, a similarity function can be defined to avoid the generation of similar counterfactuals. Given the feature vectors of two data points and a threshold indicating when the vectors are dissimilar enough, each synthetic data candidate is checked against all other data points. other constraint mechanisms may freeze the features that were changed in first counterfactual generation, forcing variations that don't cancel the previous changes.

The newly generated synthetic data points are added to the synthetic data set. By re-iterating the counterfactual generation process instead of just mutating each data point the system balances the need to get similar points, while also increasing the likelihood of getting diverse candidate data points since each candidate made it least two changes. In other words, the operations producing synthetic data points are not symmetric.

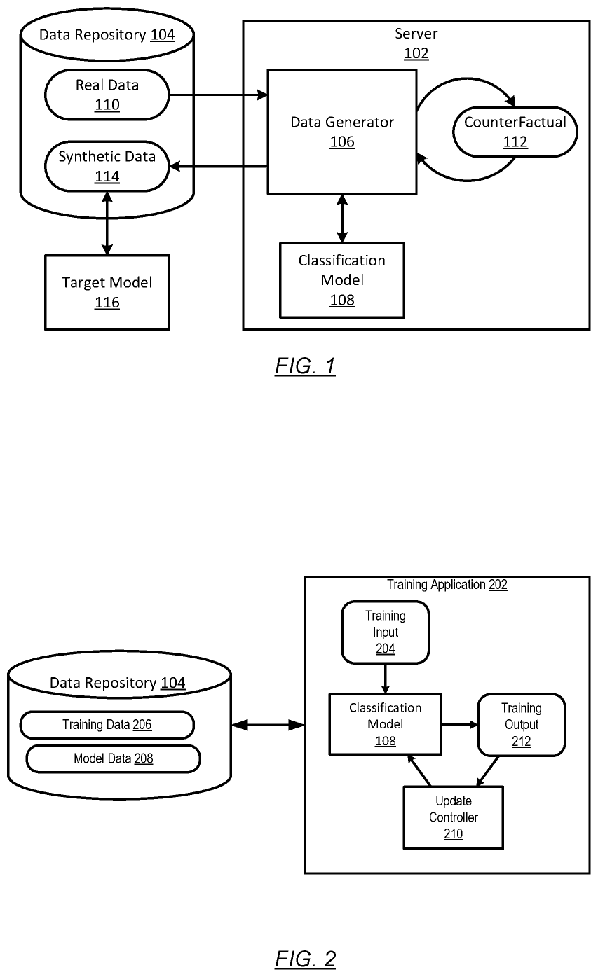

Turning to FIG. 1, the computer system (100) is illustrated for generating. synthetic data. The system (100) includes a server (102) and a data repository (104).

The server (102) is a computing system (further described in F 6A). The server (102) may include multiple physical and virtual computing systems that form part of a cloud computing environment. In one embodiment, execution of the instructions, programs, and applications of the server (102) is distributed to multiple physical and virtual computing systems in the cloud computing environment. In one embodiment, the server (102) may host applications, such as websites, and may serve structured documents (hypertext markup language (HTML) pages, extensible markup language (XML) pages, JavaScript object notation (JSON) files and messages, etc.) to interact with user devices connected via a network. As illustrated, the server (102) includes the data generator (106) and classification model (108).

The server (102) may connect to a data repository (104). In one or more embodiments of the invention, the data repository (104) is any type of storage unit and/or device (e.g., a file system, database, data structure, or any other storage mechanism) for storing data. Further, the data repository (104) may include multiple different, potentially heterogeneous, storage units and/or devices. The data repository (104) stores real data (110) and synthetic data (114).

Real data (110) is data that has been collected from natural events. For example, in one embodiment, the real data (110) may include actual images characterized by a feature space that includes image size, resolution, brightness, clarity, sharpness, saturation, hue, luminosity, image classification, etc. In one embodiment, the real data (110) may include financial data characterized by a feature space that includes records of transactions, statistical attributes (e.g., mean transaction value, modeg. 1 of transaction type, etc.), account balances, monthly income, etc.

As used herein, the term “feature space” refers to the n-dimensions of variables live (not including a target variable if it is present) in a dataset. Given some data, the feature space is the set of all possible values for a chosen set of features from that data

In contrast to real data (110), synthetic data (114) is data that has been artificially created using one or more computer algorithms. In one or more embodiments, the synthetic data (114) is generated by iteratively applying one or more counterfactual generation algorithms to real data (110).

The data generator (106) is a collection of programs with instructions that may execute on multiple servers of a cloud environment, including the server (102). The data generator (106) processes real data (110) to generate one or more counterfactual (112). For example, the data generator (106) may search for a counterfactual vector by adjusting one or more values along the dimensions of a vector space for a real vector generated from the real data (110). When input to the classification model (108), counterfactual vector generates a classification output that is different than the output generated from the real vector.

The data generator (106) processes the counterfactual (112) to generate synthetic data (110). For example, the data generator (106) may search for a synthetic vector by adjusting one or more values along the dimensions of a vector space for a counterfactuals vector generated from the counterfactual (110). When input to the classification model (108), the synthetic vector generates a classification output that is the same as the output generated from the real vector.

The data generator (106) may utilize one or more counterfactual generation libraries, such as Diverse Counterfactual Explanations (DiCE). DiCE generates counterfactual explanations as to as an optimization problem, where perturbations change the output of a machine learning model, using tunable parameters for diversity and proximity of the explanations to the original input to generate diverse and feasible feature changes.

The data generator (106) may generate counterfactuals and synthetic data using one or more different algorithms. For example, the data generator may use model agnostic methods, such as randomized samplings, k-dimensional trees, or genetic algorithms. In another example, the data generator (106) utilizes gradient based methods running on a differentiable model, such as internal network. The gradient methods can be Implemented in a differentiable model, such as a neural network, based on an expected loss and/or a variational auto encoder (VAE).

The classification model (108) is a collection of programs with instructions that may operate on the server (112). The classification. model (108) processes real data (110), the counterfactual (112), and/or the synthetic data (114) to generate an output. The model (125) may be a machine learning model. In one embodiment, the model (125) may include a neural network that processes the input vectors (123) using neural network algorithms (convolutional algorithms, transformer algorithms, attention algorithms, recurrent algorithms, etc.).

For example, the classification model (108) may take a vector representation of real data (110), the counterfactual (112), and/or the synthetic data (114) as input, and generate an output vector to a vector space delineating a particular classification. The output of the real data (110) and the synthetic data (114) may be to a selected class or satisfy a threshold, whereas the output for the counterfactual (112) may not be to the selected class or not satisfy the threshold. For example, input of a synthetic vector or real vector may generate an output that is below a threshold, but input of a counterfactual vector may generate an output that is above the threshold. In other words, the real vector and synthetic vector may be in a first vector space corresponding to a first class, while the counterfactual vector may be in a second vector space corresponding to a second class.

The target model (116) is a collection of programs with instructions that may operate on the server (102), or on another server. The target model (116) may be a machine learning model. In one embodiment, the target model (116) may include a neural network that is trained from synthetic data (114) using neural network algorithms (convolutional algorithms, transformer algorithms, attention algorithms, recurrent algorithms, etc.). when trained using synthetic data (114), using the target model (116) to process other data, such as real data (110), may comply with one or more data privacy laws or regulations.

Turning to FIG. 2, a training application is shown for training a machine learning model, according to one or more illustrative embodiments. The training application (202) may be used to train the classification model (108) of FIG. 1.

The training application (202) is a collection of programs with instructions that may execute on multiple servers of a cloud environment, including the server (102) of FIG. 1. In one embodiment, the training application (202) may operate at different times and/or on different servers than data generator (106) and/or classification model (108). The training application (202) trains the classification model (108) using training input (204) to generate training output (212).

The training input (204) may be a subset of the training data (206). The training data (206) can be a subset of real data (110), having the same feature space. In other words, the training input (204) may include input vectors having the same vector space as the input vectors generated from real data (110).

The model data (208) is data that defines the model (108). The model data (208) may include parameters, weights, hyperparameters, etc., which may be updated by the update controller (210) to improve the training output (212) of the model (108). One or more algorithms may be used by the update controller (210), including backpropagation, gradient descent, boosting, gradient boosting, etc.

Referring now to IG. 3, a data generator is shown according to one or more illustrative embodiments. The data generator of figure three shows additional components and functionality that for the data generator (106) of FIG. 1.

The feature extractor (302) processes the real data (110) with one or more numerical transformations and algorithms to generate the real vectors (304). The real vectors (304) are sets of features extracted from real data (110). For example, in one embodiment, the real data (110) includes images and the real vectors (304) include image features extracted from the data of the images, such as size, resolution, brightness, clarity, sharpness, saturation, hue, luminosity, image classification, etc. In one embodiment, the real data (110) includes financial data and the real vectors (304) include financial features extracted from the financial data, such as records of transactions, statistical attributes (e.g., mean transaction value, mode of transaction type, etc.), account balances, monthly income, etc. The order and type of input features may be the same between different input vectors for the same type of data.

Classification model (108) processes the real vectors (304) to generate scores (306) that correspond to one or more output classes (308). The output classes (308) are the classifications of the outputs from classification model (108). In one embodiment, a threshold may be used to define the output classes (308). Scores that satisfy the threshold may be to a first output class. Other scores that do not satisfy the threshold are to a second output class. Multiple thresholds and additional algorithms may be used to identify and define the output classes (129).

The data generator (106) processes real vectors (304), e.g., using a searching algorithm such as a genetic search algorithm, KD-trees, etc. The data generator (106) iteratively searches the space and dimensions of the input vector, modifying the features (308) of the real vectors (304) to find a score (306) that corresponds to a different one of output classes (308) than the real vectors (304).

When a mutated real vector generates a score that is not to a first class (e.g., below a threshold), the system (106) generates a counterfactual vector (310) that replaces enough of the input features (128) of the input vector so that the score of the counterfactual vector is to the second class (e.g., does not satisfy the threshold).

Broadly, the data generator (106) may generate counterfactual by finding solutions to the optimization problem:

$$arg {min}_{w} l ( {f}_{w} ( {x}_{i} ) , {y}_{i} ) + ρ ( w ) \qquad Equation ( 1 )$$

Equation (1) states the optimization objective, which is to minimize the distance w between the counterfactual (x′) and the original datapoint (x) subject to the constraint that the output of the classifier on the counterfactual is the desired label (y′∈Y). Converting the objective into a differentiable, unconstrained form yields the loss function:

$$arg {min}_{x ′} {max}_{λ} {λ ( {f}_{w} ( {x}^{′} ) - {y}^{′} )}^{2} + d ( x + {x}^{′} ) \qquad Equation ( 2 )$$

The first term encourages the output of the classifier on the counterfactual to be close to the desired class, and the second term forces the counterfactual to be close to the original datapoint. A metric d is used to measure the distance between two datapoints x, x′∈X, which can be the L1/L2 distance, or quadratic distance, or other distance functions which take as input the cumulative distribution function of the features or pairwise feature costs as perceived by users. A counterfactual that is classified in the desired class is a valid counterfactual.

In some embodiments, the loss function of Equation (2) may be further modified to encourage counterfactuals having additional desirable properties comma such as actionability, sparsity, adherence to observed correlations, causality, etc. For example, the original datapoint (x) to be within set of actionable features that are not immutable. The Loss function may include penalties that encourages sparsity in the distance between the modified and the original data point and/or adhering to observed correlations among features defined by the training set.

Once a valid counterfactual is found, the counterfactual vectors (310) are then fed back into the classification model (108) and the data generator (106) to generate synthetic vectors (312). Classification model (108) processes the counterfactual vectors (310) to generate scores (306) that correspond to one or more output classes (308). The data generator (106) processes real vectors (304), again using a searching algorithm to iteratively searches the space and dimensions of the counterfactual vectors, which are taken as input to the classification model, The data generator (106) modifies the features (308) of the counterfactual vectors (310) to find a score (306) that corresponds to the same output class as the real vectors (304).

When a mutated counterfactual vector generates a score that is not to the first class (e.g., above a threshold), the system (106) uses the valid counterfactual to generate synthetic data (130). The data generator opened (106) generates a synthetic vector (312) that replaces enough of the features (128) of the counterfactual vectors (310) so that the score of the synthetic vector (312) is to the first class (e.g., satisfies the threshold). The synthetic vector (312) are processed with one or more numerical transformations and algorithms to generate synthetic data (114).

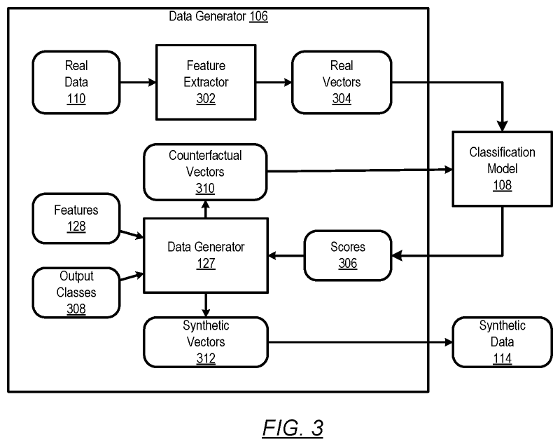

While FIG. 1, FIG. 2, and FIG. 3 show a configuration of components, other configurations may be used without departing from the scope of the invention. For example, various components may be combined to create a single component. As another example, the functionality performed by a single component may be performed by two or more components

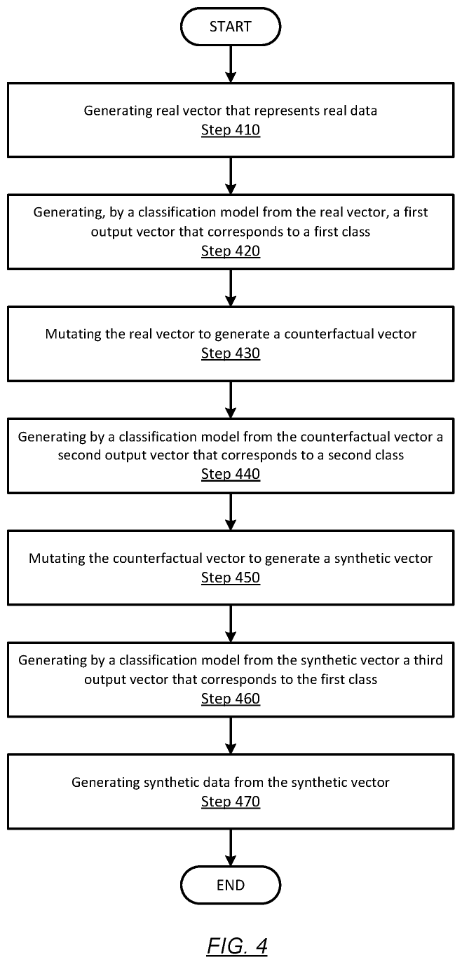

Referring now to FIG. 4, a process for generating synthetic data is shown according to one or more illustrative embodiments. The process (200) takes advantage of counterfactual generation algorithms to create synthetic data. The process (200) may be performed by a computing device interacting with one or more additional computing devices. For example, the process (200) may execute using one or more programs running on a server, such a server (102) of FIG. 1.

At step 402, a real vector is generated that represents real data. The real vector may include multiple features extracted from the real data.

At step 404, a classification model generates a first output vector from the real vector. The first output vector corresponds to a first class.

In some embodiments, the real vector is processed by the classification model. defecation model may be a machine learning model trained by processing training input to generate training output, and processing the training output to update the model to improve a characteristic of the model. in some embodiments, the classification model may include a neural network.

At step 406, the real vector is mutated to generate a counterfactual vector. For example, one or more first features of the real vector may be replaced with the one or more second features. The one or more second features are determined from a subset of a data set and where the subset corresponds to a second class. In other words, the subset of features may be selected from a feature space that corresponds to a second class.

In some embodiments, cost reductions and/or heuristic may be employed to reduce a processing overhead in finding valid counterfactuals. For example, mutating the real vector to generate a counterfactual vector may further include processing an intermediate vector to generate an intermediate score. It cost value might be determined based on a number of features that have been changed between the real vector and the intermediate vector. A heuristic value is then determined from the intermediate score, and the counterfactual vector is then searched for using the cost value and heuristic value.

In one embodiment, the cost value is determined by identifying the number of changes between an input vector and a counterfactual vector. For example, an input vector with seven input features may have three of the input features changed to counterfactual features. With three of the input vectors being changed, the cost value is three.

In one embodiment, the heuristic value is determined using an intermediate vector. In one embodiment, Equation 1 may be used.

$$( \frac{λ * d}{f} ) ( \frac{\vert s - s ′ \vert}{Δ} ) \qquad Equation ( 3 )$$

Where:

λ is a hyperparameter with a range of [0, 1]. The value may be set by a developer of the system.

d is the number of features in the intermediate vector that have been changed from input features to counterfactual features.

ƒ is the total number of features in the vectors used by the system. The total number of features may also be referred to as the number of dimensions and is the same for the input vector, intermediate vectors, counterfactual vector, etc.

S is the score attempting to be achieved. The value is a score that is within a selected class. For example, S may satisfy a threshold by being above the threshold value.

S′ is the score of the current intermediate vector being processed. When S′ satisfies S, the algorithm identifies the current intermediate vector as a counterfactual vector.

Δ is the difference between the current cost for the current intermediate vector and a previous cost for a previous vector. For example, the current cost may be “3”, indicating that three input features have been changed to counterfactual features for the current intermediate vector, and the previous cost may be “2”, indicating that two input features were changed to counterfactual features for the previous intermediate vector.

At step 408, the classification model generates a second output vector from the counterfactual vector. The second output vector corresponds to a second class.

At step 410, the counterfactual vector is mutated to generate a synthetic vector.

At step 412, the classification model generates a third output vector from the synthetic vector. The third output vector corresponds to the first class.

In some embodiments, a similarity function may define a requisite Δ between the real vector and the synthetic vector. features of the real vector and the counterfactual vector are mutated such that the Δ between the real vector and the synthetic vector satisfies the similarity function

In some embodiments, features that were mutated in the real vector are locked and/or flagged. Changes to the locked/flagged features are prevented when mutating the counterfactual vector. In other words, the synthetic vector is prevented from being a negative of the real vector, such that the mutations to the real vector and counterfactual vector do not cancel themselves.

In some embodiments, these steps of mutating the real vector, generating the output vector, and mutating the counterfactual vector may be performed derivatively, with each output vector produced by the iterations corresponding to a different class. these iterative calculations may result in a synthetic data set that is more diverse than may be produced by a single pairwise mutation.

At step 414, synthetic data is generated from the synthetic vector. The process terminates thereafter.

In some illustrative embodiments, the synthetic data is used to train a target model. when trained using synthetic data, using the target model to process other data may comply with one or more data privacy laws or regulations training a target model using synthetic data.

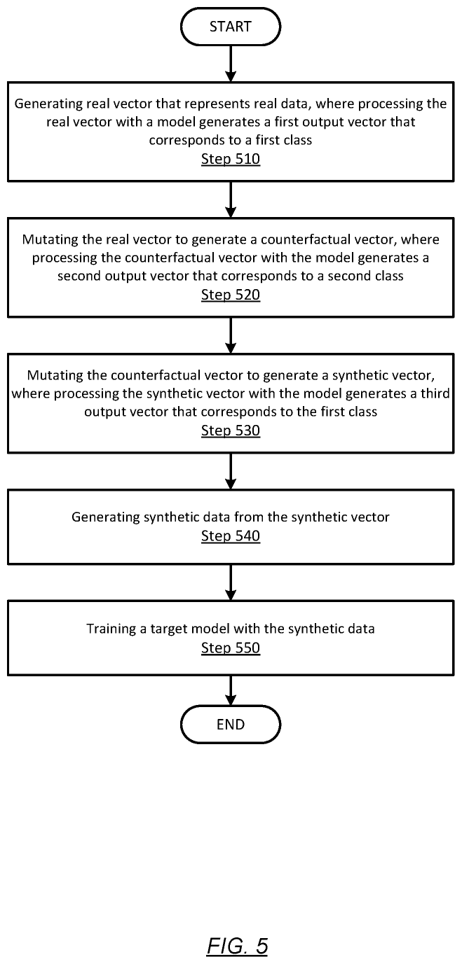

Referring now to FIG. 5, a process for generating synthetic data is shown according to one or more illustrative embodiments.

At step 502, a real vector is generated that represents real data. Processing the real vector with a model generates a first output vector that corresponds to a first class.

At step 504, the real vector is mutated to generate a counterfactual vector. Processing the counterfactual vector with the model generates a second output vector that corresponds to a second class.

At step 506, the counterfactual vector is mutated to generate a synthetic vector. Processing the synthetic vector with the model generates a third output vector that corresponds to the first class.

At step 508, synthetic data is generated from the synthetic vector. The synthetic data can then be used to train a target model, as shown at step 510.

While the various steps in the flowcharts are presented and described sequentially, at least some of the steps may be executed in different orders, may be combined or omitted, and at least some of the steps may be executed in parallel. Furthermore, the steps may be performed actively or passively.

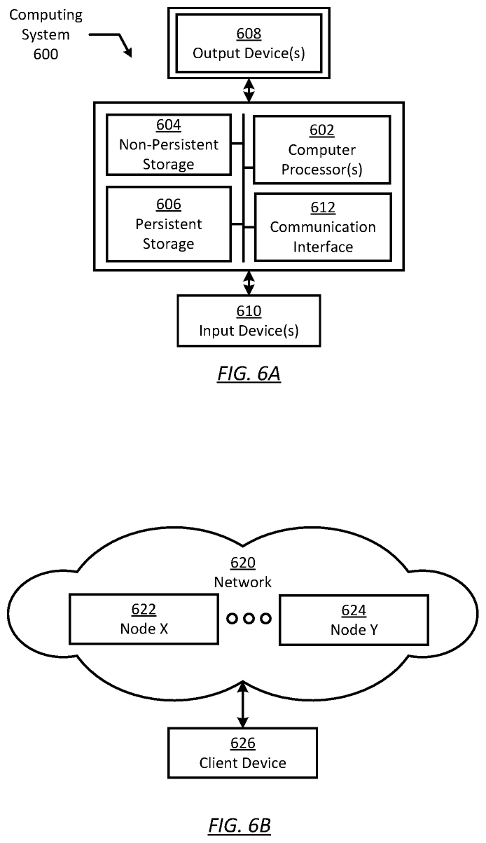

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 6A, the computing system (600) may include one or more computer processors (602), non-persistent storage (604), persistent storage (606), a communication interface (612) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) may be one or more cores or micro-cores of a processor. The computer processor(s) (602) includes one or more processors. The one or more processors may include a central processing unit (CPU), a graphics processing unit (GPU), a tensor processing unit (TPU), combinations thereof, etc.

The input devices (610) may include a touchscreen, keyboard, mouse, microphone, touchpad, electronic pen, or any other type of input device. The input devices (610) may receive inputs from a user that are responsive to data and messages presented by the output devices (608). The inputs may include text input, audio input, video input, etc., which may be processed and transmitted by the computing system (600) in accordance with the disclosure. The communication interface (612) may include an integrated circuit for connecting the computing system (600) to a network (not shown) (e.g., a local area network (LAN), a wide area network (WAN) such as the Internet, mobile network, or any other type of network) and/or to another device, such as another computing device.

Further, the output devices (608) may include a display device, a printer, external storage, or any other output device. One or more of the output devices may be the same or different from the input device(s). The input and output device(s) may be locally or remotely connected to the computer processor(s) (602). Many different types of computing systems exist, and the aforementioned input and output device(s) may take other forms. The output devices (608) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (600) in FIG. 6A may be connected to or be a part of a network. For example, as shown in FIG. 6B, the network (620) may include multiple nodes (e.g., node X (622), node Y (624)). Each node may correspond to a computing system, such as the computing system shown in FIG. 6A, or a group of nodes combined may correspond to the computing system shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622), node Y (624)) in the network (620) may be configured to provide services for a client device (626), including receiving requests and transmitting responses to the client device (626). For example, the nodes may be part of a cloud computing system. The client device (626) may be a computing system, such as the computing system shown in FIG. 6A. Further, the client device (626) may include and/or perform all or a portion of one or more embodiments of the invention.

The computing system of FIG. 6A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such includes the term “and.” Further, items joined by the term “or” may include any combination of the items with any number of each item unless, expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

1. A method for generating synthetic data, the method comprising:
generating, by a feature extractor executing on a computer processor, a real vector that represents real data from a data set of real data;
training, by a training application executing on the computer processor, a classification model to output a score corresponding to an output class of an input vector, with training data that is a subset of the data set of real data, to generate a trained classification model, comprising
generating, by the feature extractor, training vectors from the training data;
setting model data for the classification model, wherein the model data comprises at least one selected from a group consisting of parameters, weights, and hyperparameters,
processing, by the classification model executing on the computer processor, at least one training vector to generate a training output score corresponding to a training output class,
backpropagating the training output class through the classification model using at least one algorithm selected from backpropagation, gradient descent, boosting, and gradient boosting, and
based on the backpropagating, updating the at least one selected from the group consisting of parameters, weights, and hyperparameters of the model data to increase delineation of a first training output class from a second training output class;
generating, by the trained classification model processing the real vector, a first output score corresponding to a first output class;
mutating, by a data generator executing on the computer processor, the real vector to generate a counterfactual vector, comprising
replacing one or more first features of the real vector with one or more second features to generate an intermediate vector, and iteratively performing
processing the intermediate vector by the trained classification model executing on the computer processor to output an intermediate output score corresponding to an intermediate output class,
determining a cost value from a number of features changed between the real vector and the intermediate vector,
determining a heuristic value based on the intermediate score corresponding to the intermediate output class, and
further replacing the one or more first features with the one or more second features to generate the intermediate vector based on the cost value and the heuristic value, until
the intermediate score corresponds to a second output class;
generating, by the trained classification model processing the counterfactual vector, a second output score corresponding to the second output class;
mutating, by the data generator, the counterfactual vector to generate a synthetic vector, wherein the synthetic vector is different from the real vector by a requisite difference defined by a similarity function;
generating, by the trained classification model processing the synthetic vector, a third output score, corresponding to the first output class; and
generating, by the data generator, synthetic data from the synthetic vector.

2. The method of claim 1, further comprising: training a target model using the synthetic data.

3. (canceled)

4. (canceled)

5. (canceled)

6. (canceled)

7. The method of claim 1, further comprising:
defining a second similarity function between two data points and a threshold; and
mutating the real vector to generate the counterfactual vector according to the second similarity function.

8. The method of claim 1, wherein:
mutating the real vector further comprises flagging features that were changed from the real vector; and
mutating the counterfactual vector comprises changing only features that were not flagged.

9. The method of claim 1, further comprising:
iteratively performing the steps of:
mutating the real vector to generate the counterfactual vector; and
mutating the counterfactual vector to generate the synthetic vector,
wherein each counterfactual vector and synthetic vector produced by the iterations corresponds to a different class.

10. The method of claim 1, further comprising:
training a target model with the synthetic data.

11. (canceled)

12. A system comprising:
a computer processor;
memory; and
instructions stored in the memory and executable by the computer processor to cause the computer processor to perform operations, the operations comprising:
generating, by a feature extractor executing on a computer processor, a real vector that represents real data from a data set of real data;
training, by a training application executing on the computer processor, a classification model to output a score corresponding to an output class of an input vector, with training data that is a subset of the data set of real data, to generate a trained classification model, comprising
generating, by the feature extractor, training vectors from the training data,
setting model data for the classification model, wherein the model data comprises at least one selected from a group consisting of parameters, weights, and hyperparameters,
processing, by the classification model executing on the computer processor, at least one training vector to generate a training output score corresponding to a training output class,
backpropagating the training output class through the classification model using at least one algorithm selected from backpropagation, gradient descent, boosting, and gradient boosting, and
based on the backpropagating, updating the at least one selected from the group consisting of parameters, weights, and hyperparameters of the model data to increase delineation of a first training output class from a second training output class;
generating, by the trained classification model processing the real vector, a first output score corresponding to a first output class;
mutating, by a data generator executing on the computer processor, the real vector to generate a counterfactual vector, comprising
replacing one or more first features of the real vector with one or more second features to generate an intermediate vector, and iteratively performing
processing the intermediate vector by the trained classification model executing on the computer processor to output an intermediate output score corresponding to an intermediate output class,
determining a cost value from a number of features changed between the real vector and the intermediate vector,
determining a heuristic value based on the intermediate score corresponding to the intermediate output class, and
further replacing the one or more first features with the one or more second features to generate the intermediate vector based on the cost value and the heuristic value, until
the intermediate score corresponds to a second output class;
generating, by the trained classification model processing the counterfactual vector, a second output score corresponding to the second output class;
mutating, by the data generator, the counterfactual vector to generate a synthetic vector, wherein the synthetic vector is different from the real vector by a requisite difference defined by a similarity function;
generating, by the trained classification model processing the synthetic vector, a third output score, corresponding to the first output class; and
generating, by the data generator, synthetic data from the synthetic vector.

13. The system of claim 12, further comprising: training a target model using the synthetic data.

14. (canceled)

15. (canceled)

16. (canceled)

17. (canceled)

18. The system of claim 12, further comprising:
defining a second similarity function between two data points and a threshold; and
mutating the real vector to generate the counterfactual vector according to the second similarity function.

19. The system of claim 12, wherein:
mutating the real vector further comprises flagging features that were changed from the real vector; and
mutating the counterfactual vector comprises changing only features that were not flagged.

20. The system of claim 12, further comprising:
iteratively performing the steps of
mutating the real vector to generate the counterfactual vector, and
mutating the counterfactual vector to generate the synthetic vector,
wherein each counterfactual vector and synthetic vector produced by the iterations corresponds to a different class.
